(19) United States
(12) Patent Application Publication
(10) Pub. No.: US 2010/0149690 A1
(43) Pub. Date: Jun. 17, 2010

(54) MAGNETIC HEAD, METHOD OF MANUFACTURING MAGNETIC HEAD, ACTUATOR, AND MAGNETIC DISK DEVICE

(75) Inventor: Toshiyuki NAKADA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/638,777

(22) Filed: Dec. 15, 2009

(30) Foreign Application Priority Data
Dec. 17, 2008 (JP) 2008-321207

(51) Int. Cl. G11B 5/60; G11B 5/127

(52) U.S. Cl. 360/234.3; 360/110; G9B/5.104

(57) ABSTRACT

According to one embodiment, a magnetic head includes a write element, a first insulating member, and a second insulating member. The first insulating member is made of an insulating material with high rigidity. The first insulating member is formed around the write element as a surface layer of the floating surface. The second insulating member is made of an insulating material with lower rigidity than the first insulating member. The second insulating member is formed near the first insulating member around the write element beneath the surface layer of the floating surface. The first insulating member is polished on the floating surface. A portion of the floating surface where the second insulating member is arranged protrudes more than a portion of the floating surface around the write element.

### CROSS-REFERENCE TO RELATED APPLICATIONS

This application is based upon and claims the benefit of priority from Japanese Patent Application No. 2008-321207, filed Dec. 17, 2008, the entire contents of which are incorporated herein by reference.

### BACKGROUND

1. Field

One embodiment of the invention relates to a magnetic head that reads data from and writes data to a rotating magnetic disk, a method of manufacturing the magnetic head, an actuator that supports the magnetic head, and a magnetic disk device with the magnetic head.

2. Description of the Related Art

A magnetic disk device comprises a magnetic head that reads data from/writes data to a rotating magnetic disk. The magnetic head floats on the magnetic disk by the high-seed rotation of the magnetic disk and is positioned at an arbitrary position on the magnetic disk in the radial direction by an actuator. As the recording density of the magnetic disk device increases, a space between the magnetic head and the magnetic disk is narrowed, i.e., the floating height of the magnetic head is decreased, to improve the read/write performance of the magnetic head.

In recent years, a heater is arranged near the write element of the magnetic head to heat the write element to locate the read/write element closer to the side of the magnetic disk to thereby control the floating height.

If the floating height of the magnetic head decreases, the magnetic head is likely to come in contact with the magnetic disk due to disturbance. In particular, since the write element of the magnetic head is arranged closer to the outflow end side than the read element is, the write element is maximally approached to the magnetic disk. Accordingly, if the write element contacts the magnetic disk, the write element may be damaged and data may not be read/written.

To prevent the read/write element from contacting the magnetic disk, conventional technologies have been proposed in relation to polishing of the floating surface of the magnetic head, and the material and structure of the element part. Reference may be had to, for example, Japanese Patent No. 2919996, Japanese Patent Application Publication (KOKAI) No. 2000-306215, and Japanese Patent No. 4093250.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic cross-sectional view illustrating a relationship between a magnetic head and a magnetic disk according to an embodiment of the invention;

FIG. 2 is an exemplary enlarged view of a peripheral portion of a read/write element of the magnetic head in the embodiment;

FIG. 3 is an exemplary schematic view of a resist shape of the magnetic head in the embodiment;

FIG. 4 is an exemplary schematic view of a resist shape of a magnetic head of a comparative example for comparison with the embodiment;

FIG. 5A is an exemplary diagram illustrating a simulation result of pressure distribution at the time of polishing the magnetic head in the embodiment;

FIG. 5B is an exemplary diagram illustrating a simulation result of pressure distribution at the time of polishing the magnetic head in the comparative example;

FIG. 6 is an exemplary graph of a pressure profile in the core-width direction of a lower write coil extracted based on the simulation result;

FIG. 7 is an exemplary graph of a recess profile of in the direction of the core width of the lower write coil after polishing extracted based on the simulation result;

FIG. 8 is an exemplary flowchart of the process of manufacturing the magnetic head in the embodiment; and

FIG. 9 is an exemplary view of a magnetic disk device provided with the magnetic head in the embodiment.

### DETAILED DESCRIPTION

Various embodiments according to the invention will be described hereinafter with reference to the accompanying drawings. In general, according to one embodiment of the invention, a magnetic head comprises a write element, a first insulating member, and a second insulating member. The first insulating member is made of an insulating material with high rigidity. The first insulating member is configured to be formed around the write element as a surface layer of the floating surface. The second insulating member is made of an insulating material with lower rigidity than the first insulating member. The second insulating member is configured to be formed near the first insulating member around the write element beneath the surface layer of the floating surface. The first insulating member is configured to be polished on the floating surface. A portion of the floating surface where the second insulating member is arranged is configured to protrude more than a portion of the floating surface around the write element.

According to another embodiment of the invention, there is provided a method of manufacturing a magnetic head. The method comprises forming a first insulating member made of an insulating material with high rigidity around a write element of a magnetic head as a surface layer of the floating surface; forming a second insulating member made of an insulating material with lower rigidity than the first insulating member near the first insulating member around the write element beneath the surface layer of the floating surface; and polishing the first insulating member on the floating surface.

According to still another embodiment of the invention, an actuator comprises a magnetic head slider, a suspension, and an actuator arm. The magnetic head slider is configured to support a magnetic head. The suspension is configured to support the magnetic head slider. The actuator arm is configured to be coupled with the suspension. The magnetic head comprises a write element, a first insulating member, and a second insulating member. The first insulating member is made of an insulating material with high rigidity. The first insulating member is configured to be formed around the write element as a surface layer of the floating surface. The second insulating member is made of an insulating material with lower rigidity than the first insulating member. The second insulating member is configured to be formed near the first insulating member around the write element beneath the surface layer of the floating surface. The first insulating member is configured to be polished on the floating surface. A portion of the floating surface where the second insulating member is arranged is configured to protrude more than a portion of the floating surface around the write element.

According to still another embodiment of the invention, a magnetic disk device comprises a disclosure, at least one magnetic disk, and an actuator. The magnetic disk is configured to be rotatably supported by the disclosure. The actuator is configured to support a magnetic head slider that supports a magnetic head and pivotally supported by the disclosure to be movable in the radial direction of the magnetic disk. The magnetic head comprises a write element, a first insulating member, and a second insulating member. The first insulating member is made of an insulating material with high rigidity. The first insulating member is configured to be formed around the write element as a surface layer of the floating surface. The second insulating member is made of an insulating material with lower rigidity than the first insulating member. The second insulating member is configured to be formed near the first insulating member around the write element beneath the surface layer of the floating surface. The first insulating member is configured to be polished on the floating surface. A portion of the floating surface where the second insulating member is arranged is configured to protrude more than a portion of the floating surface around the write element.

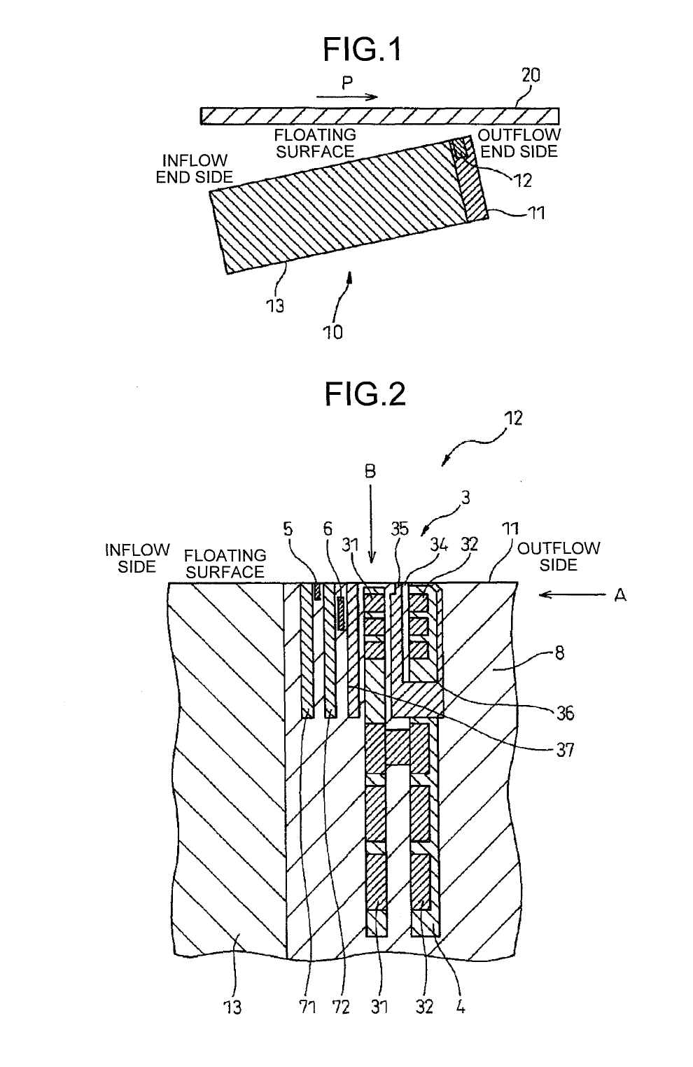

FIG. 1 is a schematic cross-sectional view illustrating a relationship between a magnetic head and a magnetic disk according to an embodiment of the invention. FIG. 1 illustrates a magnetic head slider 10, a magnetic head 11, a read/write element 12, a head board 13 that supports the magnetic head 11, and a magnetic disk 20. The magnetic head slider 10 floats on the magnetic disk 20 by the high-speed rotation of the magnetic disk 20.

In FIG. 1, an arrow P indicates the rotation direction of the magnetic disk 20. If the magnetic disk 20 rotates at a high speed in the direction indicated by the arrow P, an airflow due to the rotation of the magnetic disk 20 is generated in the same direction as the direction of the arrow P on a surface of the magnetic disk 20. The magnetic head slider 10 floats at a constant floating height due to the pressure of air flowing into a space between the magnetic head slider 10 and the magnetic disk 20. The magnetic head 11 is positioned at the outflow end of the airflow of the magnetic head slider 10, and the read/write element 12 of the magnetic head 11 faces the magnetic disk 20.

In FIG. 1, the magnetic head slider 10 is arranged to face one surface of the magnetic disk 20, but may be arranged to face the other surface of the magnetic disk 20. Further, the magnetic head slider 10 may be arranged to face both surfaces of the magnetic disk 20.

FIG. 2 is an enlarged view of a peripheral portion of the read/write element 12 of the magnetic head slider 10. The read/write element 12 comprises a write element 3 and a read element 5. The write element 3 writes data to the magnetic disk 20, while the read element 5 reads data from the magnetic disk 20.

FIG. 2 also illustrates a main yoke 35 and return yokes 36 and 37. There is a gap 34 between the main yoke 35 and the return yokes 36. The gap 34 represents a gap of the write element 3 that generates a leakage magnetic flux to write data. Write coils 31 and 32 are write coils for the write element. The write coils 31 and 32 are double coils, and generate a leakage magnetic flux in the gap 34 of the write element 3. A resist 4 is an insulating resist and is formed around the write coils 31 and 32 to insulate the write coils 31 and 32. The double coil is cited by way of example only, and a single coil or a helical coil may be used.

Shield layers 71 and 72 are provided on both sides of the read element 5. A heater 6 is provided between the return yoke 37 of the write element 3 and the shield layer 72. If power is supplied to the heater 6, the write coils 31 and 32 thermally expand, and push the read/write element 12 to protrude toward the side of the magnetic disk 20. By controlling the amount of power supplied to the heater 6, the protrusion amount of the read/write element 12 can be adjusted.

The head board 13 is made of AlTic. Alumina 8 (aluminum oxide: Al₂O₃) is used as an insulating material. The magnetic head 11 is formed by covering the read/write element 12 with the alumina 8.

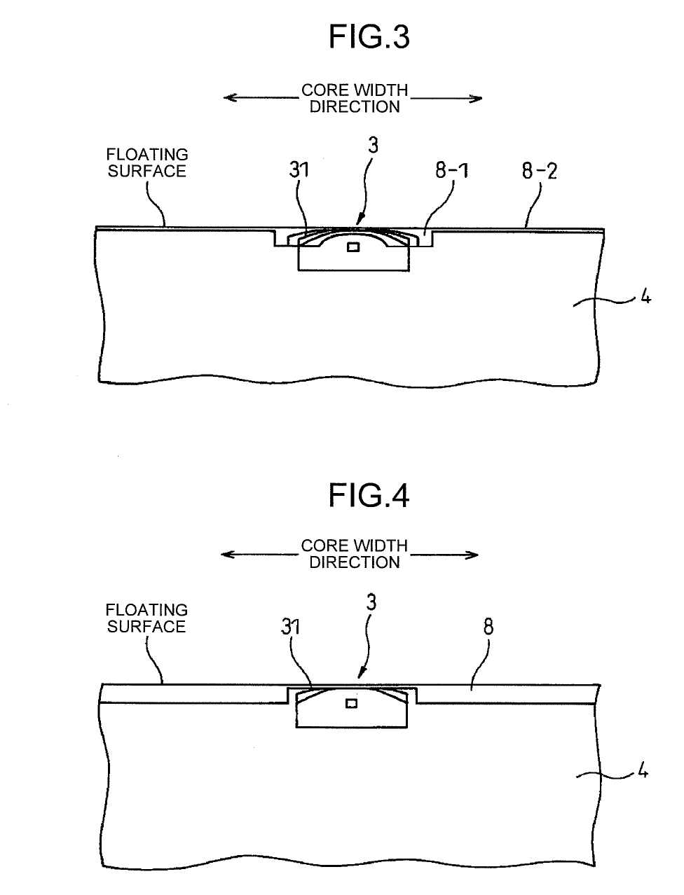

FIG. 3 schematically illustrates a resist shape in the embodiment. FIG. 3 illustrates the resist shape viewed from the B direction section of FIG. 2, i.e., when the core-width direction section of the write element 3 is viewed from A direction, and does not illustrate the detailed shapes of the write coils and others.

As illustrated in FIG. 3, in the embodiment, alumina 8-1 having high rigidity is used as an insulating material near the floating surface around the write element 3. The alumina 8-1 is also arranged on the side of the floating surface of the resist 4 that insulates the write coil 31. At positions away from the write element 3 in the core-width direction, the resist 4 having low rigidity is used as an insulating material. The positions away from the write element 3 in the core-width direction are both sides of a portion where the alumina 8-1 is arranged.

A thin alumina layer 8-2 of a thickness of 5 μm or less is provided all over the floating surface. In FIG. 3, a portion insulated by the resist of the write element 3 protrudes. The protrusion is a portion where the resist of the write coil appears.

During the polishing of the floating surface of the magnetic head 11, the polishing rate is high in a portion where pressure on a polishing surface is high, while the polishing rate is low in a portion where pressure on the polishing surface is low. Accordingly, as illustrated in FIG. 3, if the floating surface of the magnetic head 11 where an insulating layer is formed is polished, a high pressure is applied to the peripheral portion of the write element 3 formed of the alumina 8-1 having high rigidity, and the peripheral portion is polished with a high polishing rate. Meanwhile, a portion covered by the thin alumina layer 8-2 beneath which the resist 4 having low rigidity is formed has low rigidity, and the portion is polished with a lower polishing rate than the peripheral portion of the write element 3. Accordingly, after the polishing, the peripheral portion of the write element 3 where the alumina 8-1 is arranged is recessed, and the thin alumina layer 8-2 where the resist 4 is arranged protrudes. Since the protrusion that is insulated by the resist 4 at the center of FIG. 3 is the write coil 31 and the write coil 31 is made of metal, the protrusion is polished at a high polishing rate as with the alumina 8-1.

In the magnetic head 11, the write element 3 is most approached to the magnetic disk 20 and is retracted from the floating surface. Therefore, even if the magnetic head 11 contacts the magnetic disk 20, this does not affect the write element 3. Since the read element 5 is arranged closer to the inflow end side than the write element 3 is, the floating height of the read element 5 is larger than that of the write element 3. That is, by preventing the contact between the write element 3 and the magnetic disk 20, the read element 5 and the magnetic disk 20 can be prevented from contacting each other.

As an insulating material having high rigidity, a material having a Young's modulus of 50 GPa or more is preferably used. Examples of the insulating material having high rigidity include alumina and silica dioxide. As an insulating material having low rigidity, a material having a Young's modulus of 10 GPa or less is preferably used. Examples of the insulating material having low rigidity include resist, fluorine resin, amorphous fluorine resin, and polyimide.

Polishing precision is in a range of several ten nanometers to several hundred nanometers and controlled in several nanometer order. In the case of a thin alumina layer having a thickness of several micrometers, only the thin alumina layer is polished and the resist after polishing does not appear on the floating surface.

FIG. 4 illustrates a resist shape of a magnetic head of a comparative example for comparison with the embodiment. As illustrated in FIG. 4, the resist 4 is arranged near the floating surface around the write element 3, and a thin layer made of the alumina 8 is formed on the resist 4. A thick layer made of the alumina 8 is formed near the floating surface of the portion away from the write element 3.

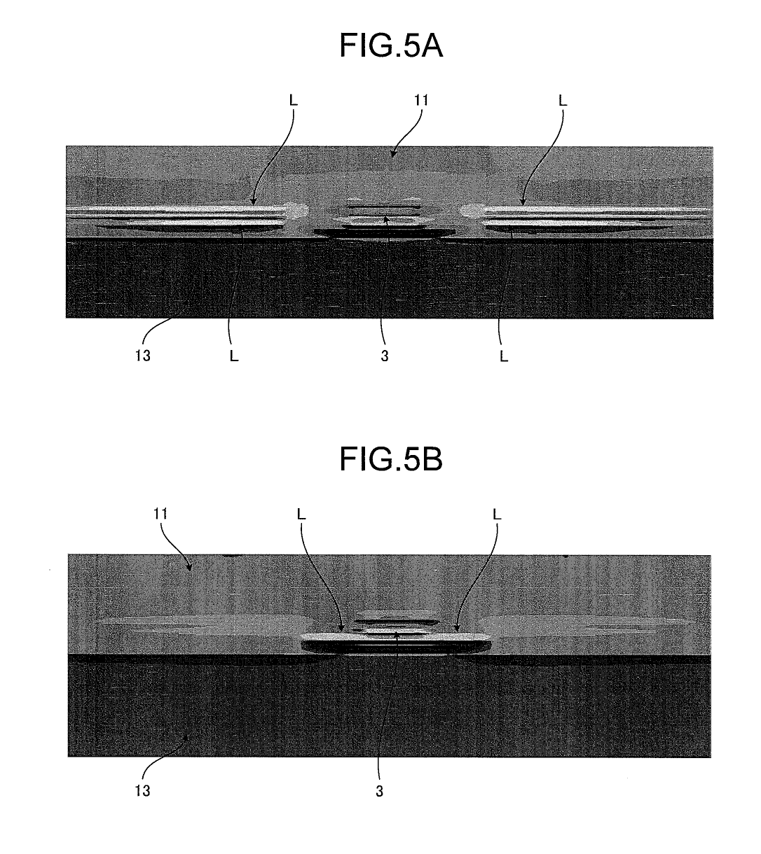

FIG. 5A illustrates a simulation result of pressure distribution on the floating surface at the time of polishing the magnetic head 11 in the embodiment. FIG. 5B illustrates a simulation result of pressure distribution on the floating surface at the time of polishing the magnetic head in the comparative example.

In FIGS. 5A and 5B, pressure distribution on the floating surface of the magnetic head slider of FIG. 2 is indicated by gradation, and the AlTic head board 13, the magnetic head 11, and the write element 3 are illustrated. A dark portion of the gradation indicates a region L with low pressure. Since the write coil portion that forms a portion of the write element 3 is made of metal, pressure on the write coil portion is the highest.

As illustrated in FIG. 5A, in the embodiment, there is no region with low pressure around the write element 3 and the region L with low pressure exists in the portion away from the write element 3. Accordingly, at the time of polishing, the peripheral portion of the write element 3 is polished more than the region L, and the write element portion is recessed more than the region L.

Meanwhile, in FIG. 5B, the region L with low pressure exists around the write element 3. Accordingly, the polishing rate is low around the write element 3, and the other regions are more polished. As a result, the write element 3 protrudes to the side of the magnetic disk.

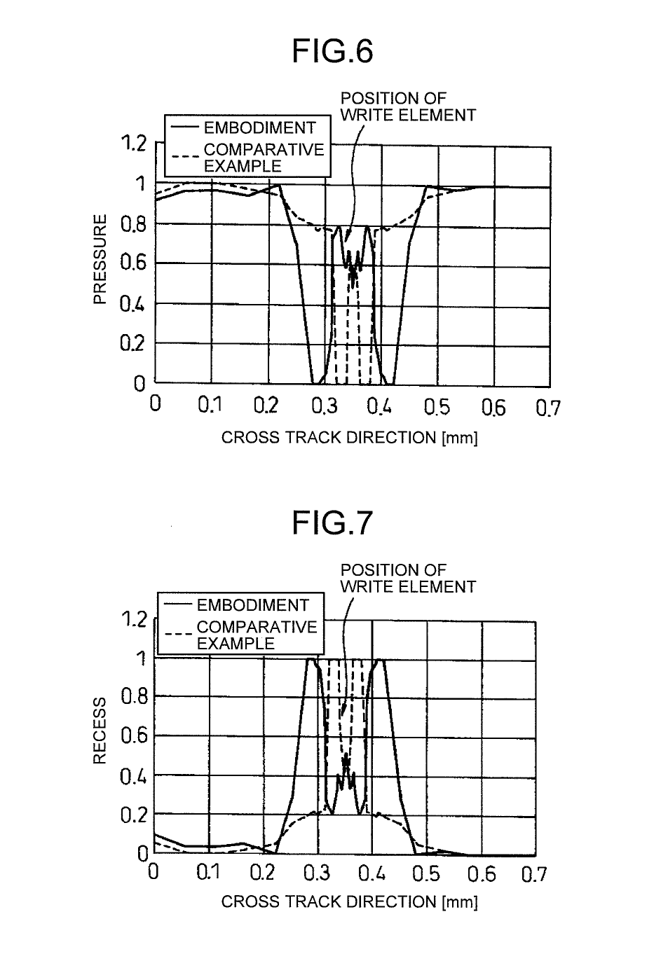

FIG. 6 illustrates a pressure profile in the core-width direction of a lower write coil extracted based on the simulation result. In FIG. 6, the vertical axis represents pressure on the floating surface at the time of polishing, while the horizontal axis represents the core-width direction. Since the core-width direction is also the direction of crossing a track on the magnetic disk, the core-width direction is illustrated as the cross-track direction in FIG. 6.

In FIG. 6, the pressure profile of the embodiment is indicated by a solid line, and the pressure profile of the comparative example is indicated by a dotted line. In the embodiment, pressure is high around the write element 3 but is low in the portion slightly away from the write element 3 in the core-width direction. Meanwhile, in the comparative example, pressure is low around the write element but is high in the portion slightly away from the write element in the core-width direction. In the embodiment and the comparative example, the high pressure portion and the low pressure portion are reversed as to the region where the write element is located.

FIG. 7 illustrates a recess profile in the core-width direction of the lower write coil after polishing extracted based on the simulation result. In FIG. 7, the recess profile of the embodiment is indicated by a solid line, and the recess profile of the comparative example is indicated by a dotted line. As illustrated in FIG. 7, in the embodiment, the write element portion is polished more than the both sides thereof and is recessed. Meanwhile, in the comparative example, the write element portion protrudes more than the other portions. Since the write coil is made of metal, in the simulation of the comparative example, only the write coil of the write element is polished with a high polishing rate.

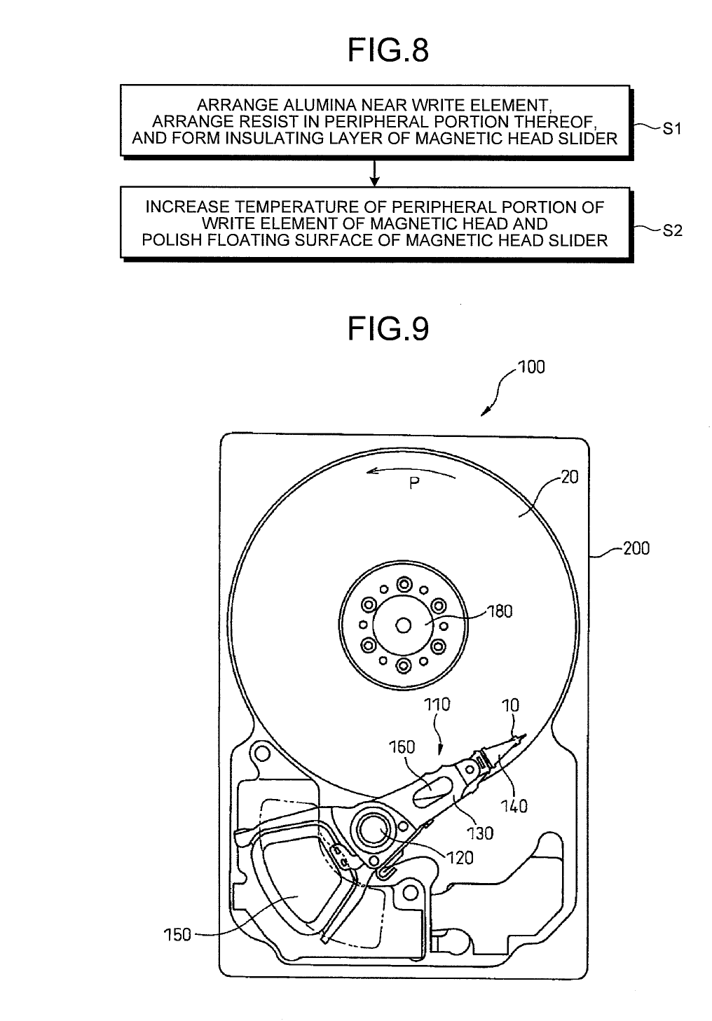

FIG. 8 is a flowchart of the process of manufacturing the magnetic head 11 in the embodiment. The magnetic head 11 of the embodiment can be manufactured by only arranging an insulating material during insulating layer formation in a conventional manufacturing process. As illustrated in FIG. 8, at S1, the alumina is arranged in the write element portion and the peripheral portion thereof on the side of the floating surface. The resist is arranged in the peripheral portion of the alumina, i.e., a portion near the floating surface and away from the write element, to form an insulating layer.

Next, at S2, the temperature of the peripheral portion of the write element 3 is controlled to be higher than the normal temperature and polishing is performed. At the time of the polishing, if the temperature of the magnetic head 11 increases, the polishing surface of the magnetic head 11 protrudes from the AlTic head board 13, and pressure on the working surface increases. Accordingly, the difference in pressure between the portion near the write element 3 where the alumina is arranged and the portion where the resist is arranged increases. At the time of the polishing, the pressure on the working surface and the polishing rate are generally proportional to each other. Accordingly, by controlling the temperature of the peripheral portion of the write element 3 of the magnetic head 11 at the time of processing, the difference in polishing amount between the portion where the alumina is arranged and the portion where the resist is arranged can be controlled. The floating surface can be polished at the normal temperature.

As described above, according to the embodiment, with the arrangement of an insulator that insulates and protects the magnetic head, the portion of the read/write element of the magnetic head can be recessed in the polishing process. Since a portion that protrudes more than the write element is formed around the write element, even if the magnetic head protrudes from the floating surface due to thermal expansion, the magnetic head can be prevented from contacting the magnetic disk. While, in the embodiment, the portion that protrudes more than the write element is formed in the core-width direction to surround the write element, it is not so limited. The portion that protrudes more than the write element may be formed around the write element in any direction. At least one portion that protrudes more than the write element suffices if the write element portion can be prevented from contacting the magnetic disk.

FIG. 9 illustrates an example of a magnetic disk device 100 that comprises an actuator provided with the magnetic head slider 10 of the embodiment.

The magnetic disk device 100 comprises at least one magnetic disk 20 that can rotate at a high speed by a spindle motor 180 and an actuator 110 that is pivotally supported to be movable in the radial direction of the magnetic disk 20 in an enclosure 200. To the front end of the actuator 110 is provided the magnetic head slider 10 that faces the magnetic disk 20. In the front end of the magnetic head slider 10, the magnetic head 11 is formed. Data is written to the magnetic disk 20 by the write element 3 of the magnetic head 11, and the written data is read by the read element 5.

The magnetic disk 20 may be one. In general, however, a plurality of magnetic disks are stacked and arranged. On the magnetic recording surface of the magnetic disk 20, a plurality of tracks are concentrically formed, and data patterns are written to sectors obtained by dividing the tracks by a predetermined length.

The actuator 110 comprises a suspension 140 that supports the magnetic head slider 10 and an actuator arm 130 that is coupled with the suspension 140 and provided with a voice coil 150. The actuator arm 130 may be formed of, for example, a thick stainless plate and supports the suspension 140. In the actuator arm 130, an opening 160 is formed to decrease the weight.

When a plurality of magnetic disks are stacked, the magnetic head sliders 10, i.e., the actuators 110, are also provided as being stacked correspondingly to magnetic recording surfaces of the magnetic disks.

The actuator arm 130 is pivotally supported by a spindle 120, and rotates about the spindle 120 due to a current flowing through the voice coil 150. The rotation of the actuator arm 130 about the spindle 120 moves the magnetic head slider 10 in the radial direction of the magnetic disk 20. By controlling the current flowing through the voice coil 150, the actuator 110 can position the magnetic head slider 10, i.e., the magnetic head 11, on an arbitrary track of the magnetic disk 20.

In the magnetic disk device provided with the magnetic head of the embodiment, the read/write element of the magnetic head can be prevented from contacting the magnetic disk, and the stability and reliability of the magnetic disk device can be improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head comprising:
a writer;
a first insulator around the writer as a surface layer of a floating surface, the first insulator comprising a first insulating material; and
a second insulator near the first insulator around the writer and beneath the surface layer of the floating surface, the second insulator comprising a second insulating material with lower rigidity than rigidity of the first insulating material, wherein
a portion of the floating surface comprising the second insulator is higher than a portion of the floating surface comprising the first insulator around the writer.

2. The magnetic head of claim 1, wherein
a Young's modulus of the first insulator is 50 GPa or greater, and
a Young's modulus of the second insulator is 10 GPa or smaller.

3. The magnetic head of claim 1, wherein the second insulator is away from the writer in a core-width direction.

4. The magnetic head of claim 1, wherein thickness of the surface layer from the floating surface over the floating surface is 5 μm or smaller.

5. The magnetic head of claim 1, wherein the floating surface is polished when a temperature of the writer is higher than a predetermined temperature.

6. The magnetic head of claim 1, wherein the first insulating material is alumina.

7. The magnetic head of claim 1, wherein the second insulating material is resist.

8. The magnetic head of claim 1, wherein the second insulating material is fluorine resin.

9. A method of manufacturing a magnetic head, comprising:
forming a first insulator comprising a first insulating material around a writer of a magnetic head as a surface layer of a floating surface;
forming a second insulator comprising a second insulating material with lower rigidity than rigidity of the first insulating material near the first insulator around the writer beneath the surface layer of the floating surface; and
polishing the first insulator on the floating surface.

10. The method of claim 9, wherein, the polishing comprises controlling a temperature of the writer to be higher than a predetermined temperature.

11. A magnetic disk device comprising:
a spindle;
at least one magnetic disk configured to spin supported by the spindle; and
an actuator configured to support a magnetic head slider comprising a magnetic head and to move in a radial direction of the magnetic disk supported by the spindle, wherein
the magnetic head comprises
a writer,
a first insulator around the writer as a surface layer of a floating surface, the first insulator comprising a first insulating material, and
a second insulator near the first insulator around the writer and beneath the surface layer of the floating surface, the second insulator comprising a second insulating material with lower rigidity than rigidity of the first insulating material, and
a portion of the floating surface comprising the second insulator is higher than a portion of the floating surface comprising the first insulator around the writer.
